(19) United States
(12) Patent Application Publication
(10) Pub. No.: US 2012/0191639 A1
(43) Pub. Date: Jul. 26, 2012

(54) STATISTICS FORECAST FOR RANGE PARTITIONED TABLES

(75) Inventors: Reinaldo T. Katahira, Anhagabau (BR); Alessandro B.A. Mariano, San Paulo (BR); Fernando de S. Parreira, Indaiatuba (BR); Pedro H.V. da Rocha, Indaiatuba (BR)

(73) Assignee: International Business Machines Corporation, Armonk, NY (US)

(21) Appl. No.: 13/014,412

(22) Filed: Jan. 26, 2011

(51) Int. Cl. G06N 5/02

(52) U.S. Cl. 706/50

(57) ABSTRACT

A method of running a query for a database having partitioned tables. The method includes loading data into a table partition; forecasting statistics for the table partition based on previously gathered partition statistics using a data mining algorithm; and subsequently to forecasting statistics, running a query by a query optimizer; and wherein the method is performed by one or more computing devices. Also disclosed is a computer program product and a system.

### BACKGROUND

The present invention relates to databases and, more particularly, relates to forecasting table partition statistics for range partitioned tables prior to running an optimal query.

Databases are well known systems for storing, searching and retrieving information stored in a computer. One type of database used today is the relational database, which stores data using a set of tables that may be reorganized and accessed in a number of different ways. Relational databases are able to represent relationships between fields within separate tables, facilitating the retrieval of relevant information. Users may access information in relational databases using a relational database management system (DBMS).

Each table in a relational database may include a set of one or more columns with each column typically specifying a name and a data type. A query of a relational database may specify which columns to retrieve data from, how to join the columns together and conditions that must be satisfied for a particular data item to be included in a query result table. Current relational databases require that queries be composed in query languages. A widely used query language is Structured Query Language (SQL). However, other query languages are also used.

Once composed, a query is executed by the DBMS. Typically, the DBMS interprets the query to determine a set of steps (i.e., an execution plan (may also be called an access plan)) that must be carried out to execute the query. Statistics may be kept pertaining to data stored in a database. Such statistics provide data for the execution plan. The DBMS may include a query optimizer (such as an SQL optimizer) which may select the execution plan that is likely to be the most efficient.

Database partitioning improves the search efficiency of the database system by avoiding the need to search an entire table. With database partitioning, a database table is divided up into sub-tables, also known as partitions. A common form of partitioning is referred to as range partitioning. With range partitioning, each individual partition corresponds to a certain range of partition values.

Table partition statistics provide important information to the query optimizer. Currently, in order to gather those statistics, at least a partial table partition scan is necessary which is consuming of time and hardware resources. However, such partial table partition scans may not provide a desired amount of accuracy. Accordingly, a full table partition scan may be necessary which is even more consuming of time and hardware resources.

### BRIEF SUMMARY

The various advantages and purposes of the exemplary embodiments as described above and hereafter are achieved by providing, according to a first aspect of the exemplary embodiments, a method of running a query for a database having partitioned tables. The method includes loading data into a table partition; forecasting statistics for the table partition based on previously gathered partition statistics using a data mining algorithm; and subsequently to forecasting statistics, running a query by a query optimizer; wherein the method is performed by one or more computing devices.

According to a second aspect of the exemplary embodiments, there is provided a computer program product for running a query for a database having partitioned tables, the computer program product including: a computer readable storage medium having computer readable program code embodied therewith. The computer readable program code including: computer readable program code configured to load data into a table partition; computer readable program code configured to forecast statistics for the table partition based on previously gathered partition statistics using a data mining algorithm; and subsequently to computer readable program code configured to forecast statistics, computer readable program code configured to run a query by a query optimizer.

According to a third aspect of the exemplary embodiments, there is provided a system including a computer readable medium, the computer readable medium having program code stored thereon for running a query for a database having partitioned tables. The program code including: program code for loading data into a table partition; program code for forecasting statistics for the table partition based on previously gathered partition statistics using a data mining algorithm; and subsequently to program code for forecasting statistics, program code for running a query by a query optimizer.

### BRIEF DESCRIPTION OF SEVERAL VIEWS OF THE DRAWINGS

The features of the exemplary embodiments believed to be novel and the elements characteristic of the exemplary embodiments are set forth with particularity in the appended claims. The Figures are for illustration purposes only and are not drawn to scale. The exemplary embodiments, both as to organization and method of operation, may best be understood by reference to the detailed description which follows taken in conjunction with the accompanying drawings in which:

FIG. 1 is an illustration of a conventional methodology to run an optimal query.

FIG. 2 is an illustration of a methodology to run an optimal query according to an exemplary embodiment.

FIG. 3 is an illustration of a methodology to run an optimal query according to another exemplary embodiment.

FIG. 4 is a chart of a range partitioned table versus allocated space.

FIG. 5 is a chart zooming in on the end of FIG. 4.

FIG. 6 is a chart of a range partitioned table versus allocated space with an overlay of predicted allocated space according to a data mining algorithm.

FIG. 7 is a chart zooming in on the end of FIG. 6.

FIG. 8 is a chart of a range partitioned table versus allocated space with an overlay of predicted allocated space according to a data mining algorithm and a second overlay of predicted allocated space according to a data mining algorithm using the days of the week as an input.

FIG. 9 is a table of predicted error rates greater than 15%.

FIG. 10 is a chart of a range partitioned table versus allocated space with an overlay of predicted allocated space according to a data mining algorithm using the days of the week as an input and a second overlay of predicted allocated space according to a data mining algorithm using the days of the week and US holidays as an input.

FIG. 11 is a block diagram of an exemplary hardware environment.

### DETAILED DESCRIPTION

The present inventors have proposed forecasting table partition statistics using data mining techniques based upon previously gathered table partition statistics to save time and hardware resources.

During the design of a database, all of the partitions may be created for a table (range partitioned by date for example) but the partitions may be empty. During processes such as Extract, Transformation and Load (ETL), the partitions are loaded with data to their respective dates. Partitions pertaining to future dates may be left empty.

Referring to the Figures in more detail, and particularly referring to FIG. 1, there is shown a conventional methodology for running a query, also known as an optimal query. A partition is loaded with data such as by ETL processes. Thereafter, a partial or full table partition scan is run to gather statistics about the table partition. The statistics may also be called metadata. As noted above, gathering statistics consumes considerable time and hardware resources. For a large table partition, gathering statistics can take an hour or more to complete. Once the statistics have been gathered, the optimal query can be run by the query optimizer such as an SQL optimizer.

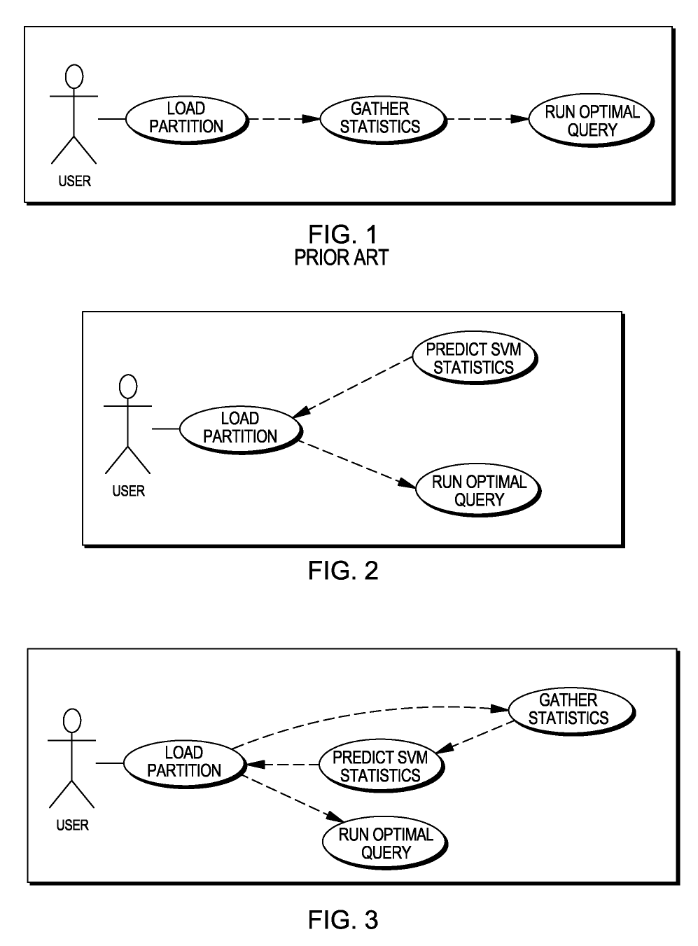

FIG. 2 illustrates the methodology of an exemplary embodiment. A table partition is loaded with data such as by ETL processes. Table partition statistics are forecast (or predicted: both forecast and predicted may be used interchangeably herein) using a data mining algorithm based upon previously gathered table partition statistics. For range partitioned tables by date, the previously gathered table partition statistics may be for one or more table partitions for earlier dates. By using previously gathered statistics and a data mining algorithm, patterns in the statistics may be recognized and used to forecast future statistics. The forecasting of table partition statistics in the exemplary embodiment may only take a few seconds to complete compared to the hour or more necessary for a full or partial table scan. When the forecasting of table partition statistics is complete, the optimal query may be run using the query optimizer. The forecasting of table partition statistics may be done before, during or after data load of the partition but before the optimal query is run. Similarly, the optimal query may also be run before, during or after the data load of the partition, but after the forecasting of table partition statistics, since table partition statistics are forecast and not gathered.

It should be understood that the use of the term “statistics” (or “metadata”) refers to information that is obtained about the table partition. In an exemplary embodiment, the statistics refer to allocated storage space for the table partition. Other exemplary embodiments may include number of rows in a table, average row length in a table, distinct values in a column, the lowest value in a column, the highest value in a column, number of null values in a column and column histograms.

FIG. 3 illustrates the methodology of a further exemplary embodiment. The exemplary embodiment shown in FIG. 3 is similar to the exemplary embodiment shown in FIG. 2 except there is now a gather statistics step. External factors such as the economy and natural disasters can dramatically influence the business directions and eventually the load of the systems and table partitions. Accordingly, it would be unwise to forecast table partition statistics indefinitely. Therefore, occasionally a partial or full table partition scan may be run as shown in FIG. 3 to provide a more accurate feedback to the data mining algorithm. Importantly, the partial or full table partition scan may be run at a convenient time such as when the database may be offline for maintenance or when demand for the database is low. In any case, the partial or full table scan is not necessary for the running of the optimal query.

Referring now to FIGS. 4 to 10, a practical application of an exemplary embodiment of the invention is illustrated. FIG. 4 shows a range partitioned table by date from 2007-05-11 until 2009-06-14 versus allocated storage space in megabytes. The statistics gathered are for allocated space in storage for the data in the table.

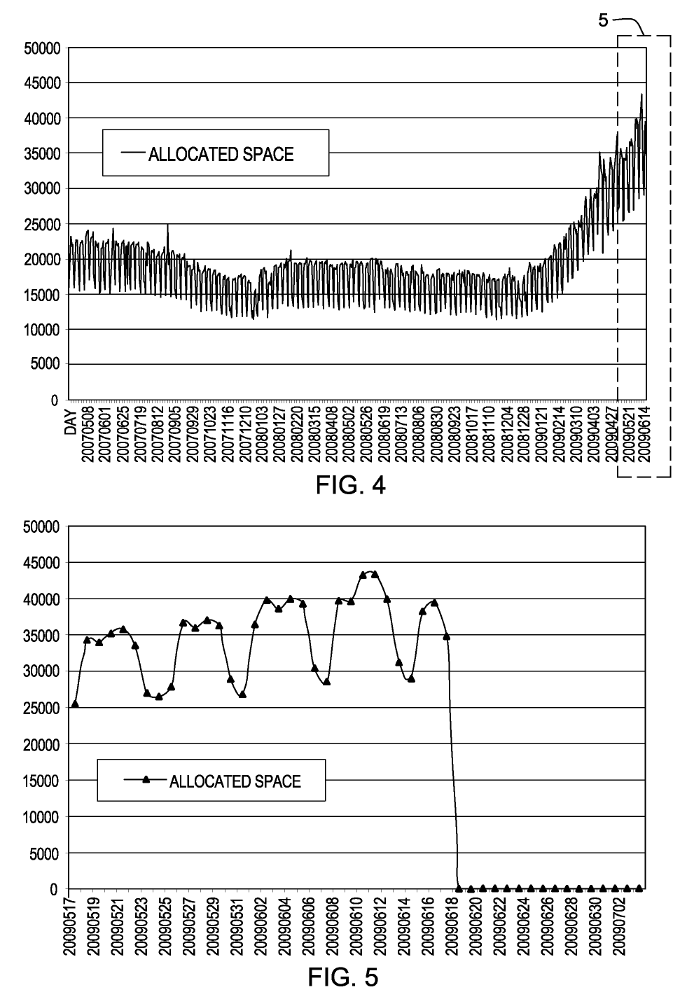

Zooming in at the end of FIG. 4, the chart is now shown in FIG. 5. Upon observing FIG. 5, it can be seen that the next partition to have data loaded, 2009-06-18, will probably allocate space between about 35000 and 45000 megabytes.

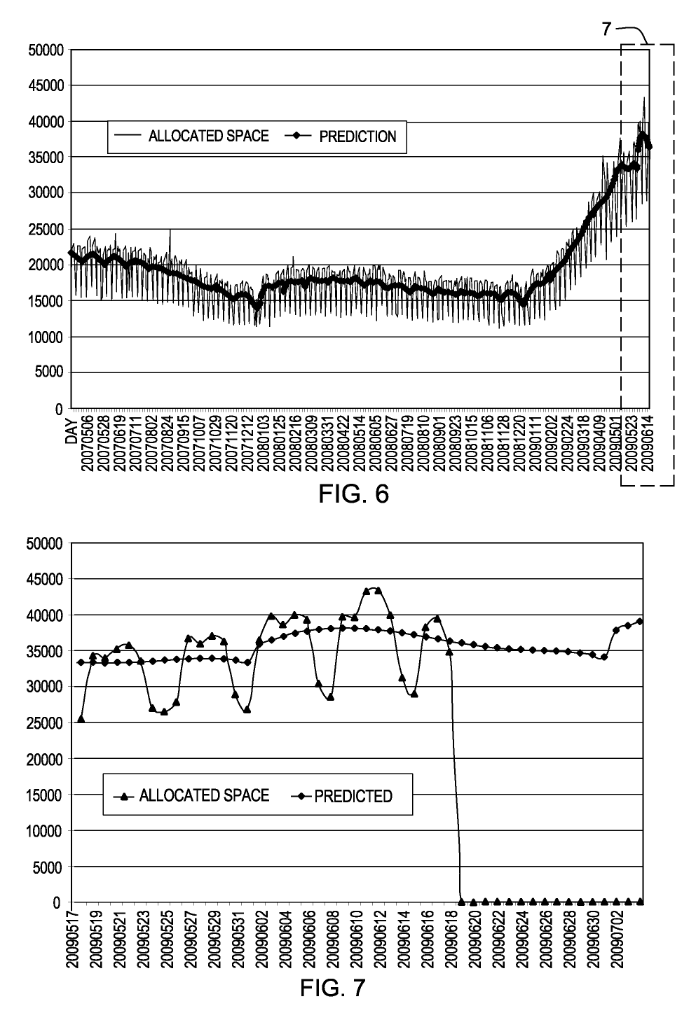

A data mining algorithm is now applied to the statistics shown in FIG. 4. The data mining algorithm may be selected from those data mining algorithms known to those skilled in the art. Two such data mining algorithms may be the Autoregressive Moving Average (ARIMA) and Support Vector Machine (SVM) algorithms, with the SVM algorithm being more preferred for the exemplary embodiments. FIG. 6 shows the results of the predicted allocated storage space overlaying the actual allocated storage. The results were produced using Oracle Data Miner software (Oracle Corporation). Other data mining software may also be used such as the IBM SPSS Statistics from IBM Corporation. The following parameters were used in the SVM algorithm: Gaussian kernel function, standard deviation 0.508197, complexity factor 0.510547, epsilon 0.022535 and convergence tolerance 0.001. The end of FIG. 6 is again zoomed in to show the predicted allocated storage space for table partitions not yet loaded. Again, it is forecast that the storage allocation for table partitions not yet loaded will be between 35,000 and 45,000 megabytes. However, it would be desirable to improve the accuracy of the predicted storage allocation space

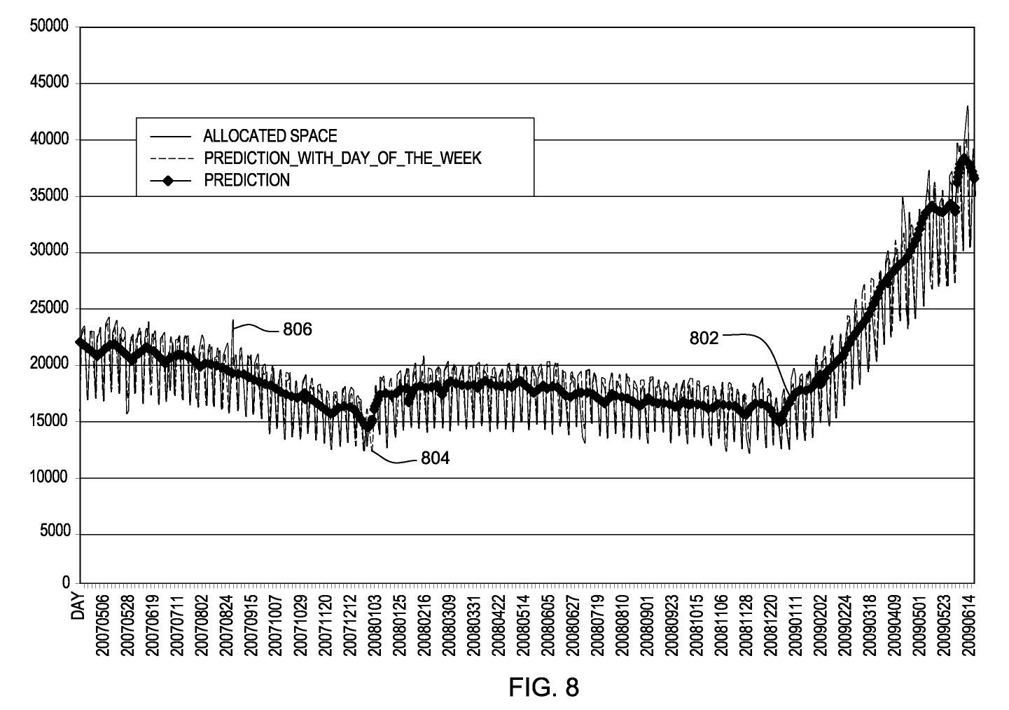

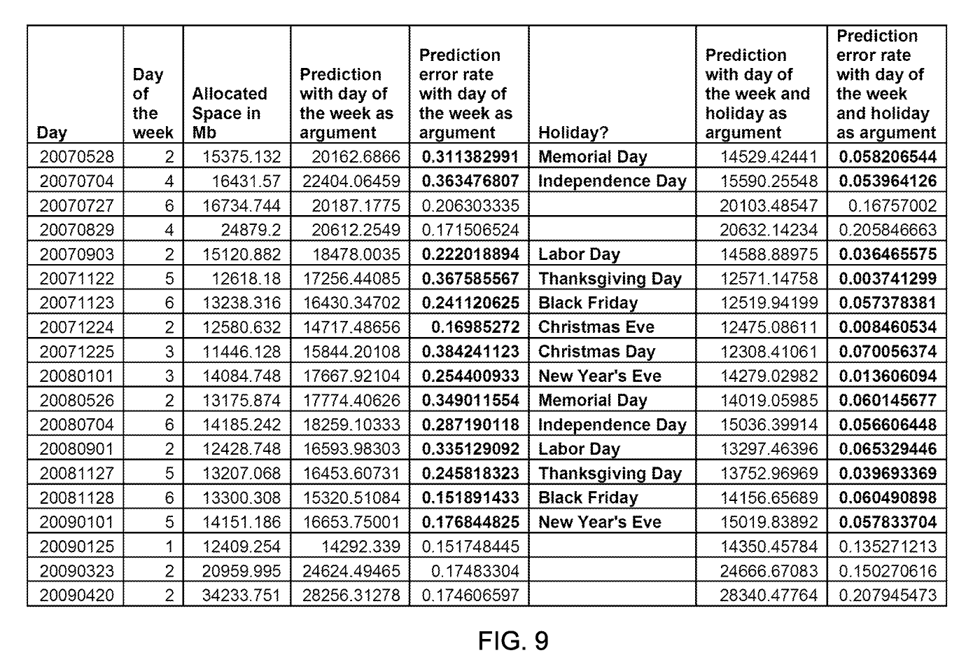

The present inventors noticed that the day of the week may directly influence the behavior of the trend. The day of the week was introduced into the SVM algorithm with number 1 for Sunday, number 2 for Monday, number 3 for Tuesday, number 4 for Wednesday, number 5 for Thursday, number 6 for Friday and number 7 for Saturday. The above input parameters were also used. The results are shown in FIG. 8. The first predicted storage allocation indicated by 802 was able to follow the general seasonal trend and the yearly and monthly averages were pretty accurate as can be seen in the peak (2009-05-23) and troughs (2008-01-03 and 2009-01-11) although the within week trend was not accurately predicted. Running the SVM algorithm again after providing the day of the week as an input parameter to the SVM algorithm, the within week trend, indicated by 804, accurately followed the actual allocated space, indicated by 806.

The error rate was next considered. The error rate using the SVM algorithm was around 12% for the predicted statistics according to line 802 in FIG. 8. However, after applying the day of the week as the input parameter, the error rate dramatically goes down to about 4% for the predicted statistics of line 804.

These error rates may be compared to a full table partition scan which is 100% accurate. A partial table scan is the most commonly used table partition scan and the accuracy is sometimes questionable. The error rate for a partial table partition scan may be variable depending upon the data distribution but in general the error rate converged to about 5% which is comparable to the error rate using the data mining algorithm having the day of the week as an input but is much more costly in terms of time and consumption of hardware resources.

The present methodology can be further improved by accounting for variances due to holidays. In those instances in which there was greater than a 15% prediction error rate, most reflect a United States holiday. The SVM algorithm was modified to include a Boolean “holiday flag” which dramatically lowered the error rate for the variances due to holidays. Referring to FIG. 9, there is a table of instances in which the prediction error rate is above 15%. In most of those instances, the prediction error rate can be reduced to around 5% or less. For example, the first instance in the table in FIG. 9 shows a prediction error rate of 31% when the holiday is Memorial Day but when the holiday is accounted for in the SVM algorithm, the prediction error rate drops to 5.8%. Those instances having greater than a 15% prediction error rate and which correlate to a United States holiday are in hold.

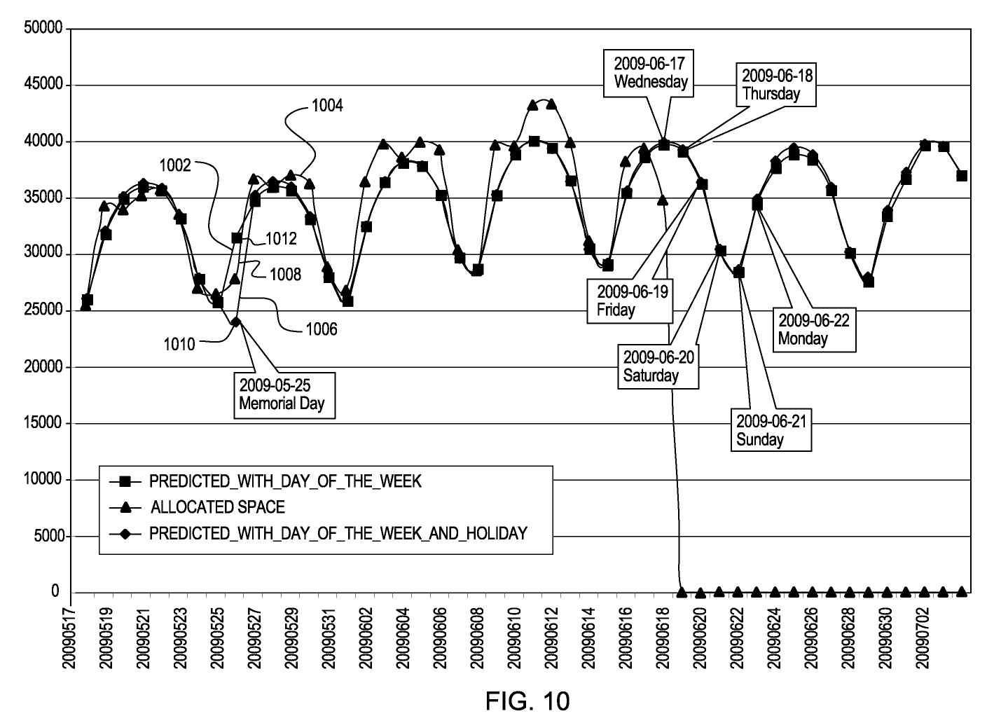

FIG. 10 shows the predicted statistics wherein days of the week and holidays are accounted for. The predicted statistics with day of the week only, line 1002, follow the actual allocated storage space, line 1004, very closely and thus are expected to accurately predict the statistics for those table partitions which have not yet been loaded. The predicted statistics with day of the week and holiday, line 1006, more accurately follow the actual allocated storage space, line 1004. That is, point 1010 on line 1006 predicting statistics with days of the week and holiday is closer to point 1008 on line 1004 for the actual allocated storage space than point 1012 on line 1002 predicting statistics with days of the week only.

In further exemplary embodiments, the data mining algorithm may be further modified to consider other factors such as the season and the financial quarter of the year.

It should be understood that the exemplary embodiments shown herein, and particularly the practical application of an exemplary embodiment shown in FIGS. 4 to 10, are for illustration purposes only and are not meant to be limiting as to the uses of the present invention. Other applications for forecasting statistics (metadata) in range partitioned tables will become apparent to those skilled in the art.

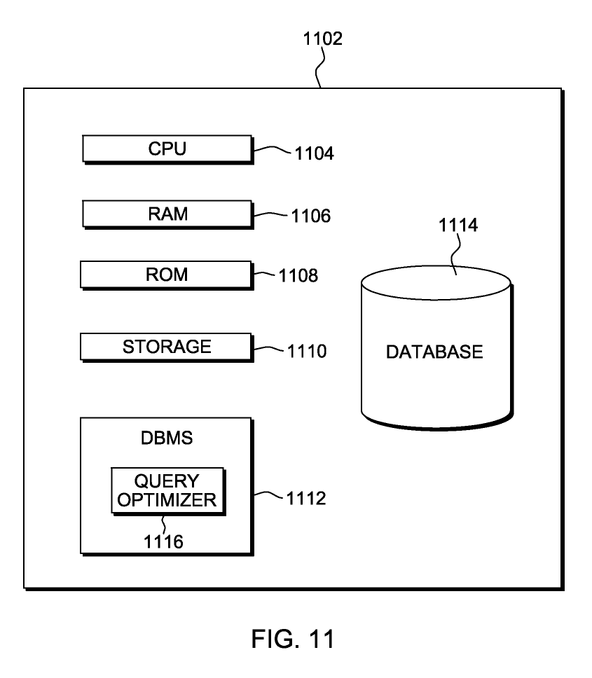

The hardware environment in which an exemplary embodiment of the invention may be executed illustratively incorporates a general-purpose computer, a server or other computing device. FIG. 11 is a block diagram that illustrates one exemplary hardware environment of the present invention. The exemplary embodiments may be implemented using a computer 1102 comprised of central processing unit (CPU) 1104, random access memory (RAM) 1106, read-only memory (ROM) 1108 and other components. The computer may be a personal computer, mainframe computer or other computing device. Resident in the computer 1102, or peripheral to it, will be a storage device 1110 of some type such as a hard disk drive, solid-state drive (SSD), floppy disk drive, CD-ROM drive, tape drive or other storage device.

Generally speaking, the software implementation of the exemplary embodiments is tangibly embodied in a computer-readable medium such as one of the storage devices 1110 mentioned above. The computer-readable medium comprises instructions which, when read and executed by the CPU 1104 of the computer 1102 causes the computer 1102 to perform the steps necessary to execute the steps or elements of the exemplary embodiments.

Computer 1102 may also comprise a database management system (DBMS) 1112 and database 1114 containing data stored in tables and table partitions. The database 1114 may be located in computer 1102 or peripheral to it. The DBMS 1112 may provide a software application to organize, analyze and modify data stored in database 1114. The DBMS may include a query optimizer 1116 configured to select an efficient query plan, or series of executed instructions, for executing a query.

As will be appreciated by one skilled in the art, aspects of the exemplary embodiments may be embodied as a system, method, service method or computer program product. Accordingly, aspects of the exemplary embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the exemplary embodiments may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the exemplary embodiments may be written in any combination of one or more programming languages, including an object oriented programming language such as Java, Smalltalk, C++ or the like and conventional procedural programming languages, such as the “C” programming language or similar programming languages or even Microsoft Excel/Access. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the exemplary embodiments have been described above with reference to flowchart illustrations and/or block diagrams of methods, apparatus (systems) and computer program products according to the exemplary embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and/or block diagrams in the Figures illustrate the architecture, functionality, and operation of possible implementations of systems, methods, service methods and computer program products according to the exemplary embodiments. In this regard, each block in the flowchart or block diagrams may represent a module, segment, or portion of code, which comprises one of more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be apparent to those skilled in the art having regard to this disclosure that other modifications of the exemplary embodiments beyond those embodiments specifically described here may be made without departing from the spirit of the invention. Accordingly, such modifications are considered within the scope of the invention as limited solely by the appended claims.

What is claimed is:

1. A method of running a query for a database having partitioned tables comprising:
loading data into a table partition;
forecasting statistics for the table partition based on previously gathered partition statistics using a data mining algorithm; and
subsequently to forecasting statistics, running a query by a query optimizer;
wherein the method is performed by one or more computing devices.

2. The method of claim 1 wherein the query is a Structured Query Language (SQL) query and the query optimizer is an SQL query optimizer.

3. The method of claim 1 wherein the table partition is a range-partitioned table partition.

4. The method of claim 4 wherein the table partition is a range-partitioned table partition by date.

5. The method of claim 1 wherein after running a query, further comprising running a partial table partition scan.

6. The method of claim 1 further comprising avoiding gathering statistics for the table partition prior to running a query.

7. The method of claim 1 wherein the data mining algorithm recognizes patterns in a quantity of known statistics and predicts future statistics based on the known statistics.

8. The method of claim 1 wherein the data mining algorithm is a Support Vector Machine algorithm.

9. The method of claim 1 wherein at least one day of the week is an input to the data mining algorithm.

10. The method of claim 1 wherein at least one holiday is an input to the data mining algorithm.

11. A computer program product for running a query for a database having partitioned tables, the computer program product comprising:
a computer readable storage medium having computer readable program code embodied therewith, the computer readable program code comprising:
computer readable program code configured to load data into a table partition:
computer readable program code configured to forecast statistics for the table partition based on previously gathered partition statistics using a data mining algorithm; and
subsequently to computer readable program code configured to forecast statistics, computer readable program code configured to run a query by a query optimizer.

12. The computer program product of claim 11 wherein the query is a Structured Query Language (SQL) query and the query optimizer is an SQL query optimizer.

13. The computer program product of claim 11 wherein the table partition is a range-partitioned table partition by date.

14. The computer program product of claim 11 wherein after computer readable program code configured to run a query, further comprising computer readable program code configured to run a table partition scan.

15. The computer program product of claim 11 wherein the data mining algorithm recognizes patterns in a quantity of known statistics and predicts future statistics based on the known statistics.

16. The computer program product of claim 11 further comprising computer readable program code configured to avoid gathering statistics for the table partition prior to running a query.

17. The computer program product of claim 11 wherein at least one day of the week is an input to the data mining algorithm.

18. The computer program product of claim 11 wherein at least one holiday is an input to the data mining algorithm.

19. A system including a computer readable medium, the computer readable medium having program code stored thereon for running a query for a database having partitioned tables, the program code comprising:
program code for loading data into a table partition;
program code for forecasting statistics for the table partition based on previously gathered partition statistics using a data mining algorithm; and
subsequently to program code for forecasting statistics, program code for running a query by a query optimizer.
